(19) United States
(12) Patent Application Publication
(10) Pub. No.: US 2026/0089450 A1
(43) Pub. Date: Mar. 26, 2026

(54) Noise Reduction for Hearing Aid

(71) Applicant: Anker Innovations Technology Co., Ltd., Changsha (CN)

(72) Inventor: Lei Li, Changsha (CN)

(21) Appl. No.: 19/330,066

(22) Filed: Sep. 16, 2025

(30) Foreign Application Priority Data
Sep. 24, 2024 (CN) 202411337259.5

(51) Int. Cl. H04R 25/00; H04R 1/10

(52) U.S. Cl. CPC H04R 25/507; H04R 1/1083; H04R 25/606; H04R 2225/41; H04R 2225/43; H04R 2460/01; H04R 2460/13

(57) ABSTRACT

The application describes noise reduction for a hearing aid. A method comprises: identifying an environmental scene based on a sound signal collected by a microphone of the hearing aid. The method further comprises determining, for a user, a first signal-to-noise ratio based on the user achieving a maximum speech recognition rate in the environment scene with the hearing aid; and determining, for the user, a second signal-to-noise ratio based on the user achieving a predetermined speech recognition threshold in the environment scene with the hearing aid. The method further comprises performing noise reduction on the sound signal based on the first signal-to-noise ratio or the second signal-to-noise ratio.

### CROSS-REFERENCE TO RELATED APPLICATION

The present disclosure claims priority to CN Application No. 202411337259.5, filed on September 24, 2025. The above application is hereby incorporated in its entirety.

### FIELD

The present disclosure relates to the technical field of audio processing, in particular to a noise reduction method for a sound signal and a hearing aid.

### BACKGROUND

Hearing aids are mainly used to help people with hearing impairment improve their hearing, so that they can better perceive and understand sounds. With the increase of environmental noise, the hearing aids need to reduce noise in a complex sound environment to improve user’s auditory experience.

Currently, noise reduction methods in hearing aids are typically implemented by setting noise reduction intensity levels, which are adjusted by a hearing care professional according to the user’s condition, or by applying corresponding noise reduction schemes targeted at specific frequencies or specific scenarios. However, the above noise reduction methods are difficult to meet users’ noise reduction expectations.

### SUMMARY

Regarding the above technical problem, it is desirable to provide a noise reduction method for a hearing aid having better noise reduction effect.

In a first aspect, the disclosure provides a noise reduction method comprising: identifying an environmental scene based on a sound signal collected by a microphone; determining, for a user, a first signal-to-noise ratio based on the user achieving a maximum speech recognition rate in the environment scene with the hearing aid; determining, for the user, a second signal-to-noise ratio based on the user achieving a predetermined speech recognition threshold in the environment scene with the hearing aid; and performing noise reduction on the sound signal based on the first signal-to-noise ratio or the second signal-to-noise ratio.

In a second aspect, the disclosure further provides a hearing aid comprising a microphone, a speaker, a bone conduction vibrator, and a processor, the processor being connected with the microphone, the speaker and the bone conduction vibrator, in which the bone conduction vibrator is configured to identify the user’s intention based on the captured vibration signal and send the identified user’s intention to the processor. The microphone is configured to collect sound signals and send the sound signals to the processor; and the processor is configured to perform the steps in the above noise reduction method for the sound signal, perform noise reduction on the sound signals, and send the noise-reduced sound signals to the speaker for output.

According to the noise reduction method for a sound signal and the hearing aid, the environmental scene corresponding to the sound signal can be identified based on the sound signal collected by the microphone, a signal-to-noise ratio (e.g., the first signal-to-noise ratio) corresponding to a user’s maximum speech recognition score in this scene and another signal-to-noise ratio (e.g., the second signal-to-noise ratio) corresponding to a user’s speech recognition threshold can be determined based on the environmental scene, so as to quantify the user’s tolerance and sensitivity to noise. Noise reduction is performed based on the first signal-to-noise ratio or the second signal-to-noise ratio, so that the noise reduction can effectively remove noise without excessively weakening useful signals, thus achieving personalized noise reduction effect according to noise tolerance of the user and environmental conditions, and enabling the user to hear clearer voices in various environments. Moreover, the above solutions can automatically adjust a noise reduction strategy according to different environmental scenes, which is suitable for various noise environments and improves adaptability and flexibility.

### BRIEF DESCRIPTION OF THE DRAWINGS

In order to more clearly illustrate technical solutions in the disclosure, the drawings that need to be used in description of the examples are briefly introduced below, and it is apparent that the accompanying drawings described below are merely some examples of the present disclosure, and for those of ordinary skill in the art, other drawings may be obtained based on these drawings without inventive work.

FIG. 1 is a schematic flowchart of a noise reduction method for a sound signal according to an example of the disclosure;

FIG. 2 is a schematic flowchart of steps of identifying an environmental scene in an example of the disclosure;

FIG. 3 is a schematic flowchart of steps of identifying an environmental scene in another example of the disclosure;

FIG. 4 is a schematic flowchart of noise reduction steps in an example of the disclosure;

FIG. 5 is a schematic flowchart of noise reduction steps in another example of the disclosure;

FIG. 6 is a structure diagram of a noise reduction apparatus for a sound signal in an example of the disclosure;

FIG. 7 is a structure diagram of a noise reduction apparatus for a sound signal in another example of the disclosure;

FIG. 8 is a structure diagram of a hearing aid in an example of the disclosure; and

FIG. 9 is an internal structure diagram of a computer device in an example of the disclosure.

### DETAILED DESCRIPTION

In order to make the object, technical solutions, and advantages of the present disclosure clearer and easier to understand, further detailed description of the present disclosure is made with reference to accompanying drawings and examples below. It can be understood that the specific examples described herein are merely for explaining the present disclosure and are not for limiting the present disclosure.

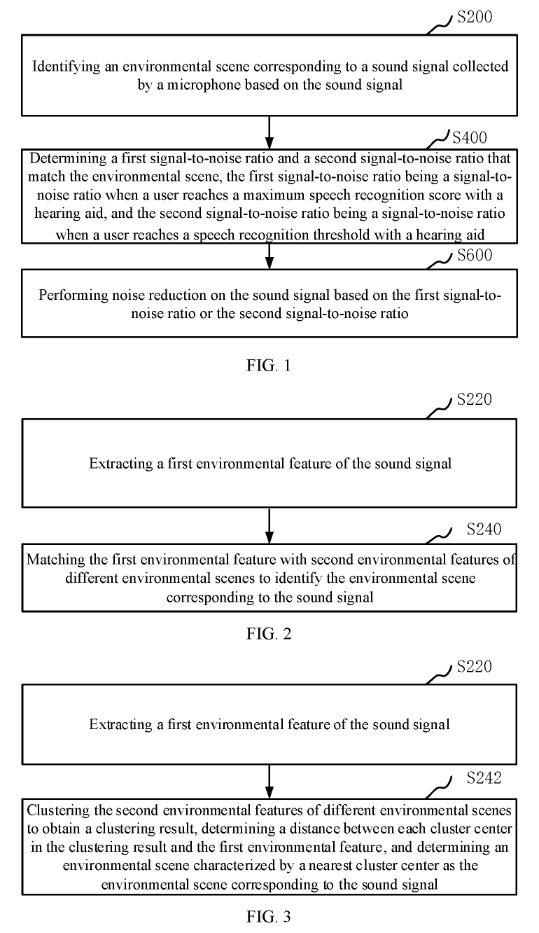

In an example, as shown in FIG. 1, a noise reduction method for a sound signal is provided. In this example, this method is applied to (e.g., performed by) an auditory assistance device such as a hearing aid. It can be understood that this method can also be applied to a server and a system including the hearing aid and the server, and can be realized through interaction between the hearing aid and the server. This method can also be applied to headphones or earphones with hearing aid functions. In this example, the method comprises steps S200 to S600.

In S200, an environmental scene corresponding to a sound signal collected by a microphone is determined (e.g., identified) based on the sound signal.

In this example, the environmental scenes may include, but not be limited to, various scenes such as quiet environments, meetings, street traffic, noisy restaurants, shopping malls, mahjong parlors, and gyms. A hearing aid may be a daily necessity for users with moderate or severe hearing loss. Users usually wear the hearing aid for a long time, and may wear the hearing aid in various life scenes. Therefore, it is desirable to identify various environmental scenes and meet the hearing requirements based on the environmental scenes.

In specific implementation, taking the auditory assistance device being a hearing aid as an example, it can be a microphone built in the hearing aid that continuously collects surrounding sound signals, which may include target speech and background noise. The collected sound signals may be preprocessed to extract key environmental features and sound features. The sound features can include spectrum characteristics, energy distribution, statistics in time domain and frequency domain, and the like. The extracted environmental features and sound features can be analyzed by using a pre-trained classifier (such as a support vector machine or a neural network) to identify a current environmental scene. It can be understood that because users may go to different scenes in an actual wearing and use process, an identification process of environmental scenes may be a continuous and ongoing process, which helps to automatically adjust a noise reduction strategy according to change of scenes, so as to meet noise reduction requirements of the users.

In S400, a first signal-to-noise ratio (SNR or S/N) and a second signal-to-noise ratio that match the environmental scene are determined. The first signal-to-noise ratio may be a signal-to-noise ratio when a user reaches a maximum speech recognition score with a hearing aid, and the second signal-to-noise ratio may be a signal-to-noise ratio for noise corresponding to a speech recognition threshold of the user.

A signal-to-noise ratio is a ratio of signal power to noise power, which is usually expressed in decibels (dB). The signal-to-noise ratio is an index to measure the intensity of a signal relative to intensity of noise (e.g., background noise), which directly affects the quality and intelligibility of the signal. The speech recognition score can be expressed in percentage (e.g., a proportion of a number of speech materials correctly recognized by a subject to a total number of test materials). The speech recognition score is an important index to evaluate individual speech comprehension ability. The maximum speech recognition score refers to a highest speech recognition score that the user can reach under most ideal conditions, such as a quiet environment. The speech recognition threshold (SRT) refers to a lowest sound level at which the user can correctly recognize, for example, half (50%) of the speech materials (e.g., a signal-to-noise ratio when the user can recognize 50% of the speech materials).

In an example, the first signal-to-noise ratio refers to the signal-to-noise ratio when the user reaches the maximum speech recognition score. The first signal-to-noise ratio may include a signal-to-noise ratio when the user reaches the maximum speech recognition score in a quiet environment or a signal-to-noise ratio when the user reaches the maximum speech recognition score in a noisy environment. The second signal-to-noise ratio refers to the signal-to-noise ratio when the user can identify a threshold percentage (e.g., 50%) of the speech materials. Similarly, the second signal-to-noise ratio may include the signal-to-noise ratio when the user can identify, for example, 50% of the speech materials in the quiet environment or the noisy environment.

In practical applications, even if the user has fitted noise reduction parameters in a quiet environment and the speech recognition threshold has reached an expected target value, the user may face situations where the noise is too loud to hear clearly in the noisy environment and noise reduction effect is not adapted in various scenes, which needs repeated adjustment but is still poor. In order to achieve personalized noise reduction, a large number of environmental scenes can be pre-recorded, and a plurality of (e.g., K) typical environmental scenes can be clustered. Then, users of the hearing aid are tested for speech recognition thresholds in different environmental scenes to determine speech recognition thresholds of the users in different environmental scenes, as well as signal-to-noise ratios required to achieve different speech recognition scores, so as to quantify user’s tolerance and sensitivity to noise.

Specifically, in a fitting room and after the user wears the hearing aid, signal-to-noise ratios (referred to as first signal-to-noise ratios SNR1) when the user reaches the highest speech recognition score of X% with a hearing aid and signal-to-noise ratios (referred to as second signal-to-noise ratios SNR2) when the user reaches a speech recognition score of 50% (e.g., the speech recognition threshold) in different environmental scenes can be measured. Then, the first signal-to-noise ratios and the second signal-to-noise ratios corresponding to the different environmental scenes are stored.

In specific implementation, after an environmental scene where the user is currently located is identified, a first signal-to-noise ratio and a second signal-to-noise ratio matching the identified environmental scene can be searched from pre-stored corresponding relationships between the environmental scenes and the first signal-to-noise ratios as well as the second signal-to-noise ratios. For example, if the identified environmental scene is a conference scene, a first signal-to-noise ratio and a second signal-to-noise ratio matching the conference scene are obtained. In other examples, the sound signal can be directly processed by an AI (Artificial Intelligence) processing model to identify a corresponding environmental scene and determine the first signal-to-noise ratio and the second signal-to-noise ratio of the environmental scene.

In S600, noise reduction is performed on the sound signal based on the first signal-to-noise ratio or the second signal-to-noise ratio.

After the first signal-to-noise ratio and the second signal-to-noise ratio matching the environmental scene are determined, a noise reduction target can be determined based on the first signal-to-noise ratio and/or the second signal-to-noise ratio, and signal processing parameters can be adjusted. After further compression and gain adjustment, the processed sound signal can be output to the user through a speaker of the hearing aid. For example, if it is necessary to adjust the noise reduction target based on the first signal-to-noise ratio SNR1, a signal-to-noise ratio of the output sound signal reaches SNR1 as far as possible. In other examples, the noise reduction strategy can be adjusted based on the first signal-to-noise ratio or the second signal-to-noise ratio in combination with a will (e.g., intention) whether the user wants to speak.

Further, the hearing aid also may include a user feedback mechanism, which allows the user to adjust a noise reduction level or other parameters. For example, the user can adjust the noise reduction level through a button on the hearing aid or a supporting smart phone application. Parameters of the hearing aid can be further adjusted to optimize performance according to the user’s feedback and preferences. For example, if the user feeds back that the signal-to-noise ratio parameter set in a specific scene causes the user not to hear clearly, the hearing aid can automatically learn and optimize a noise reduction strategy in this scene.

In the noise reduction method for the sound signal, signal-to-noise ratios (first signal-to-noise ratios) corresponding to maximum speech recognition scores and signal-to-noise ratios (second signal-to-noise ratios) corresponding to speech recognition thresholds of the user in different environmental scenes are determined in advance, so as to quantify the user’s tolerance and sensitivity to different noise levels. In a practical application, the environmental scene corresponding to the sound signal can be identified based on the sound signal collected by the microphone, then the first signal-to-noise ratio and the second signal-to-noise ratio matching the environmental scene are acquired, and noise reduction is performed based on the first signal-to-noise ratio or the second signal-to-noise ratio, so that the noise reduction can effectively remove noise without excessively weakening useful signals, thus achieving personalized noise reduction effect according to noise tolerance of the user and environmental conditions, and enabling the user to hear clearer voices in various environments. Moreover, the above method(s) can automatically adjust a noise reduction strategy according to different environmental scenes, which is suitable for various noise environments and improves adaptability and flexibility.

In some examples, before determining the first signal-to-noise ratio and the second signal-to-noise ratio matching the environmental scene, the method may further include: performing speech recognition threshold tests under information masking on the user under different signal-to-noise ratio levels in various environmental scenes to obtain test results, and determining the first signal-to-noise ratios and the second signal-to-noise ratios for the user in the different environmental scenes according to the test results and the user’s hearing data.

The speech recognition threshold tests under information masking aim to evaluate ability of individuals to recognize speech in presence of informational noise. The informational noise refers to noise similar to a speech signal in spectrum. The user’s hearing data includes, but is not limited to, audiogram and hearing loss types. Because the user may go to various environmental scenes in their life, sound signals can be collected and recorded in N environmental scenes, and then the N environmental scenes are projected into high-dimensional space through a clustering algorithm such as a K-means algorithm or an artificial intelligence algorithm to select K typical environmental scenes, including conference scenes, various traffic scenes, restaurant scenes, shopping mall scenes and family scenes.

Standardized speech test materials may be prepared, including speech signals and informational noise, such as speech signals containing disyllabic words and informational noise. A speech recognition score test may be performed on the user in the quiet environment based on the user’s audiogram and hearing loss type to determine a signal-to-noise ratio when the user reaches a highest speech recognition score of X% in the quiet environment. Then, the hearing aid may be fitted based on this signal-to-noise ratio parameter to set relevant noise reduction parameters.

An environmental scene N1 is selected from the K typical scenes, and the user A1 wears the fitted hearing aid and turns off a noise reduction function. The test may start from a high signal-to-noise ratio (SNR) such as 25 dB, so as to ensure that the user can easily recognize speech materials. Given the sound signal, speech test materials (such as 10 disyllabic words) are played to the user with background noise being played at the same time, the user repeatedly dictate heard words, and feedback data of the user is collected to get a speech recognition score under a current SNR. Subsequently, the signal-to-noise ratio is gradually reduced, for example, by 5 dB each time (for example, from 25 dB to 20 dB and then to 15 dB, etc.), and the above steps are repeated until it is difficult for the user to correctly recognize more than half of the speech test materials. When the user can correctly recognize x% of the test materials under a certain signal-to-noise ratio, this signal-to-noise ratio may be recorded as A1_N1_SRTx which includes a signal-to-noise ratio (e.g., the first signal-to-noise ratio) corresponding to a highest speech recognition score the user can reach. When the user can correctly recognize a percentage (e.g., 50%) of the speech test materials under a certain signal-to-noise ratio, this signal-to-noise ratio may be recorded as A1_N1_SRT50 (e.g., the second signal-to-noise ratio). For example, it is assumed that the user has a highest speech recognition score of x% (for example, 90%) in the quiet environment (regarded as a scene N1), the test can start from a signal-to-noise ratio of 25 dB, which is gradually decreased. It is assumed that the user can correctly recognize 90% of the test materials at a signal-to-noise ratio of y1 dB. At this time, A1_N1_SRTx = y1 dB. Then, the signal-to-noise ratio continues to be reduced until the user can only correctly recognize 50% of the test materials. It is assumed that the user can correctly recognize 50% of the test materials at a signal-to-noise ratio of y2 dB. Therefore, A1_N1_SRT50 = y2 dB.

For each subsequent selected environmental scene (such as N2, N3, ..., Nk), the above testing process is repeated to obtain A1_Nk_SRTx and A1_Nk_SRT50 of the user in each environmental scene. Likewise, A1_Nk_SRTx and A1_Nk_SRT50 in each environmental scene obtained above can be of initial values, and the user can fine-tune and calibrate A1_Nk_SRTx and A1_Nk_SRT50 in each environmental scene through the feedback mechanism to determine final A1_Nk_SRTx and A1_Nk_SRT50 in each environmental scene.

In addition, if the user cannot reach the fitting room for the speech recognition threshold test, the user can also perform the test by himself. The user wears the hearing aid, and the built-in microphone of the hearing aid collects external sound signals. Then, sound features in the sound signals are extracted, and a current scene of the user can be identified through a scene recognition algorithm. Alternatively, the sound features are clustered with sound features in the K typical scenes in a test environment to match a most similar typical scene, then noise reduction is performed based on SRTx and SRT50 in the matched most similar typical scene, the processed sound signal is output to the user and prompts the user to confirm whether it is necessary to adjust noise reduction intensity. If the user needs to adjust the noise reduction level or other parameters, the hearing aid can further adjust the noise reduction parameters according to user’s feedback and preference, so as to obtain SRTx and SRT50 of the user in different environmental scenes.

In this example, the speech recognition threshold test is performed on the user by combining the standardized test materials and the user’s hearing data in different environmental scenes, so that the user’s tolerance and sensitivity to different noise levels can be quantified, and thus a basis for personalized adjustment of the hearing aid can be provided to improve the user’s hearing experience.

There may be various ways to identify an environmental scene. As shown in FIG. 2, in some examples, identifying the environmental scene corresponding to the sound signal comprises following steps.

In S220, a first environmental feature of the sound signal is extracted.

In S240, the first environmental feature is matched with second environmental features of different environmental scenes to identify the environmental scene corresponding to the sound signal.

The environmental feature refers to a feature that describes attributes of an acoustic environment, which is used to identify and distinguish different environmental scenes. The environmental feature includes, but is not limited to, a frequency spectrum feature, a time domain feature, a modulation feature and a statistical feature such as a mean and a variance of signals.

In a practical application, a classifier can be trained in advance based on training data including historical environmental features (e.g., second environmental features) in various environmental scenes, and the classifier is configured to predict an environmental scene according to the environmental feature. After the microphone collects the sound signal in the current scene, the collected sound signal can be preprocessed to extract the environmental feature in the sound signal. Then, the extracted environmental features are input into the trained classifier, and the classifier outputs a predicted environmental scene to obtain the environmental scene corresponding to the sound signal.

In other examples, the second environmental features of different environmental scenes can be determined in advance. In practical application, after the first environmental feature of the sound signal collected by the microphone is extracted, similarity matching can be performed between the extracted first environmental feature and the second environmental features of different environmental scenes to find out a second environmental feature most similar to this environmental feature, and an environmental scene corresponding to this second environmental feature can be determined as the environmental scene corresponding to the sound signal.

In this example, scene prediction is performed based on environmental features in various environmental scenes, which can improve accuracy in environmental scene classification.

Matching of the environmental feature can be achieved in a clustering manner. As shown in FIG. 3, in some examples, the step S240 includes a step S242 in which the second environmental features of different environmental scenes are clustered to obtain a clustering result, a distance between each cluster center in the clustering result and the first environmental feature is determined, and an environmental scene characterized by a nearest cluster center is determined as the environmental scene corresponding to the sound signal.

There may be many second environmental features of different environmental scenes, and there may be correlation between the second environmental features themselves. Continuing from the previous example, after the environmental feature of the sound signal is extracted, the second environmental features in the different environmental scenes can be clustered by the clustering algorithm, and an appropriate number of clusters can be determined by an elbow rule. The extracted second environmental features are clustered based on the number of clusters so as to determine a cluster center in each cluster and obtain the clustering result. This cluster center characterizes a typical feature of the cluster. Then, a distance between each cluster center and the first environmental feature, such as a Euclidean distance, is calculated, and an environmental scene characterized by a nearest cluster center is determined as an environmental scene most similar to an environment in which the user is currently located, and the environmental scene characterized by this cluster center can be determined as the environmental scene corresponding to the sound signal.

In this example, by clustering analysis of the environmental features of different environmental scenes, the environmental scene in which the user is currently located can be identified more accurately, and the clustering analysis can automatically adjust the cluster center to adapt to matching of a new environmental scene.

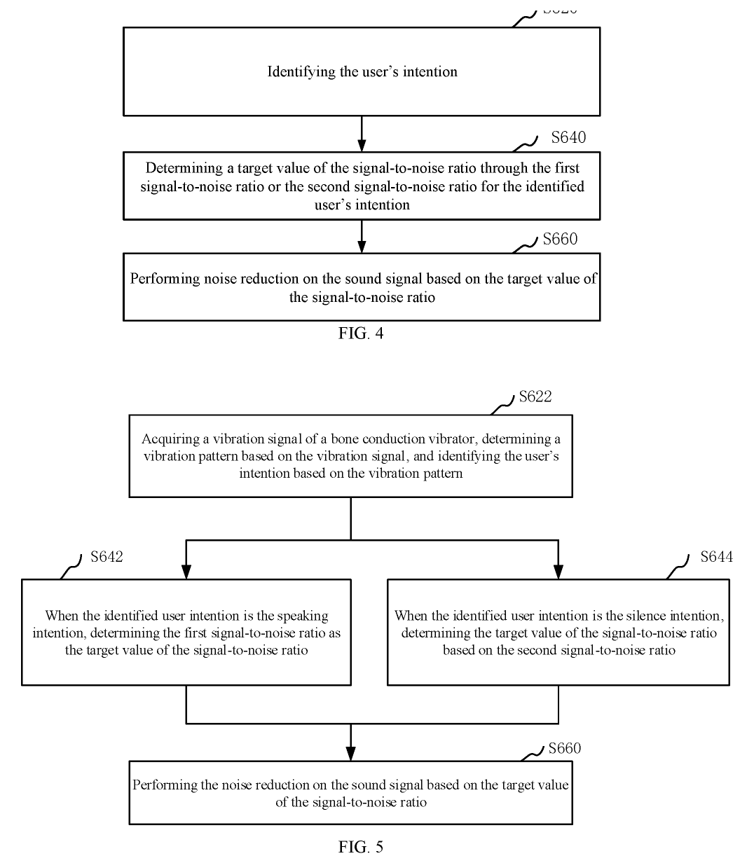

Considering that the personalized noise reduction is optimum to combine subjective willingness of users to achieve more personalized noise reduction effect, in an example, as shown in FIG. 4, the step S600 comprises steps S620 to S660.

In S620, a user’s intention is identified.

In S640, a target value of the signal-to-noise ratio is determined through the first signal-to-noise ratio or the second signal-to-noise ratio for the identified user’s intention.

In S660, noise reduction is performed on the sound signal based on the target value of the signal-to-noise ratio.

In this example, the user’s intention mainly refers to the user’s subjective willingness to contact the outside world, including but not limited to speaking intention and silence intention. The speaking intention indicates that the user wants to pay more attention to communication with others and hopes to have good communication with each other. The silence intention indicates that the user doesn’t want to talk or communicate with others.

In specific implementation, the hearing aid can analyze the collected sound signals through a pre-trained classifier to identify the user’s intention. For example, if it is recognized that the user has an obvious conversation part, it can be determined that the user’s intention is the speaking intention. Subsequently, the first signal-to-noise ratio or the second signal-to-noise ratio can be selected based on the identified user’s intention, and a target value of the signal-to-noise ratio can be determined, and thus the noise reduction strategy is adjusted.

In this example, a better personalized noise reduction effect can be achieved by identifying the user’s intention and selecting the first signal-to-noise ratio or the second signal-to-noise ratio according to the user’s intention to adjust the noise reduction level.

As shown in FIG. 5, in some examples, the step S620 includes a step S622 in which a vibration signal of a bone conduction vibrator is acquired, and the user’s intention is identified based on the vibration signal.

The bone conduction vibrator can also be a bone voiceprint sensor. In practical applications, there may be a bone conduction vibrator in the hearing aid. When the user speaks, the user mainly generates sound by vibration of vocal cords. When air flows through the vocal cords, the vocal cords may vibrate and generate the sound. When the sound passes through resonant cavities such as an oral cavity, a nasal cavity and a pharyngeal cavity, tiny vibration and resonant of bones and soft tissues in these parts may be caused, thus enhancing and changing characteristics of the sound. The bone conduction vibrator can capture a vibration signal of the vocal cords and a tiny vibration signal of the resonant cavities, so as to determine whether the user is speaking.

In a specific implementation, the user’s intention can be identified by the bone conduction vibrator built in the hearing aid. The bone conduction vibrator may be installed at an inner side of a housing of the hearing aid to be close to head and face bones of the user, so as to effectively capture a vibration signal generated when the user speaks. When the bone conduction vibrator captures vibration signals of the user’s vocal cords and resonant cavities, the captured vibration signals can be pre-processed, such as filtered or enhanced. Then, key features can be extracted from the pre-processed vibration signals, which are related to a vibration pattern in speaking, such as a vibration frequency and amplitude. Then, it is identified whether the user is speaking based on the extracted key features, so as to determine the user’s intention. For example, with a set threshold, when a feature value of the captured vibration signal exceeds a threshold, it is determined that the user is speaking, otherwise, it is determined that the user is in a non-speaking state (e.g., not speaking). In this example, the bone conduction vibrator captures the vibration signal to identify the user’s intention, which can accurately capture the vibration signal of the user and accurately identify the user’s intention in a noisy environment.

In some examples, the step of identifying the user’s intention based on the vibration signal includes determining a vibration pattern based on the vibration signal and identifying the user’s intention based on the vibration pattern.

In this example, the vibration pattern mainly includes a first vibration pattern in a speaking state and a second vibration pattern in a non-speaking state. The second vibration pattern includes but is not limited to modes such as chewing, swallowing, and coughing.

Specifically, features extracted from the vibration signal can be analyzed by a preset vibration pattern recognition algorithm to determine whether the vibration pattern is the first vibration pattern in the speaking state or the second vibration pattern in the non-speaking state. If the vibration pattern is the first vibration pattern, it is determined that the user’s intention is the speaking intention, and if the vibration pattern is the second vibration pattern, it is determined that the user’s intention is the silence intention.

In addition, it is also possible to collect a large number of vibration signals of the user in the speaking state and extract a first vibration feature in the vibration signals; and collect a vibration signal of the user in the non-speaking state, extract a second vibration feature in the vibration signal, add a vibration mode tag for the first vibration feature and the second vibration feature, and then train a vibration pattern identification model based on the tagged first and second vibration features. In practical applications, the vibration signal output by the bone conduction vibrator is collected, feature data is extracted and input into the trained vibration pattern recognition model to determine the vibration pattern. If the vibration pattern is the first vibration pattern, it is determined that the user’s intention is the speaking intention; if the vibration pattern is the second vibration pattern, it is determined that the user’s intention is the silence intention. In addition, the feedback mechanism can also be used to confirm whether the user’s intention is determined correctly. If the hearing aid misjudges that the user is speaking, the user can be asked to confirm whether the user is speaking through a sound prompt or tactile feedback.

In this example, by analyzing a specific vibration pattern and identifying the user’s intention based on the vibration pattern, the user’s actual speaking intention can be more accurately distinguished from other oral activities (such as chewing and swallowing), thus improving user experience.

Illustratively, as shown in FIG. 5, in other examples, the step S640 comprises following steps S642 and S644.

In S642, when the identified user’s intention is the speaking intention, the first signal-to-noise ratio is determined as the target value of the signal-to-noise ratio.

In S644, when the identified user’s intention is the silence intention, the target value of the signal-to-noise ratio is determined based on the second signal-to-noise ratio.

For example, if the user’s intention is the speaking intention, it indicates that the user wants to speak or is speaking, and a goal of noise reduction is to improve speech clarity to the greatest extent, which indicates that more noise reduction is needed. At this time, the first signal-to-noise ratio when the user reaches the maximum speech recognition score in the noisy environment can be determined as the target value of the signal-to-noise ratio, and the noise reduction can be performed on the sound signal based on this target value of the signal-to-noise ratio.

If the user’s intention is the silence intention, it indicates that the user doesn’t want to speak, and a goal of noise reduction is to make the user contact with more sounds in a case where the noise does not make the user feel uncomfortable, so as to keep abundance of environmental sounds. Therefore, the target value of the signal-to-noise ratio can be set slightly higher than the second signal-to-noise ratio. In other examples, the target value of the signal-to-noise ratio can also be directly set as the second signal-to-noise ratio, and the target value of the signal-to-noise ratio can also be determined in combination with user requirements.

In this example, the target value of noise reduction is determined by identifying the user’s intention, and the noise reduction is performed on the sound signal based on the target value, which can significantly improve the user’s hearing experience and provide the user with more personalized and efficient hearing aid experience.

In other examples, the step in which the target value of the signal-to-noise ratio is determined based on the second signal-to-noise ratio includes following contents.

A suggested value (e.g., a target value) of the signal-to-noise ratio may be determined based on the second signal-to-noise ratio, the suggested value of the signal-to-noise ratio being greater than the second signal-to-noise ratio.

Signal-to-noise ratio information with the suggested value of the signal-to-noise ratio can be pushed for the user to adjust to obtain the target value of the signal-to-noise ratio based on the suggested value of the signal-to-noise ratio. The target value of the signal-to-noise ratio fed back by the user is received.

In this example, the suggested value of the signal-to-noise ratio can be understood as a preliminarily determined signal-to-noise ratio value to be confirmed by the user, and can be regarded as a suggested reference value of the signal-to-noise ratio. As described in the previous example, in order to expose users to more sounds and preserve the abundance of environmental sounds, the suggested value of the signal-to-noise ratio determined based on the second signal-to-noise ratio is slightly higher than the second signal-to-noise ratio. For example, if the second signal-to-noise ratio is 5 dB, the determined suggested value of the signal-to-noise ratio can be 7 dB.

The target value of the signal-to-noise ratio is a signal-to-noise ratio determined by the user based on the user’s own needs and the suggested value of the signal-to-noise ratio, which is configured to characterize a signal-to-noise ratio level that the user expects to achieve. In this example, the user can determine whether to adopt the suggested value of the signal-to-noise ratio according to his own needs and actual situations after receiving the signal-to-noise ratio information with the suggested value of the signal-to-noise ratio, or set a signal-to-noise ratio that meets his own expectation based on the suggested value of the signal-to-noise ratio, so as to determine the target value of the signal-to-noise ratio.

In specific implementation, in order to make the noise reduction effect meet the user’s expectation, the signal-to-noise ratio information with the suggested value of the signal-to-noise ratio can be pushed. The signal-to-noise ratio information can be pushed by voice for the user to confirm whether the suggested value of the signal-to-noise ratio needs to be adjusted, and to feed back the target value of the signal-to-noise ratio that meets his own expectation.

In some examples, in order to achieve personalized noise reduction, the sound signal can be noise-reduced according to the suggested value of the signal-to-noise ratio and output to the user, and then the signal-to-noise ratio information with the suggested value of the signal-to-noise ratio is pushed to the user for the user to confirm whether the suggested value of the signal-to-noise ratio needs to be adjusted. If the suggested value needs to be adjusted, the user can fine-tune and calibrate the current noise reduction level through a button on the hearing aid or a supporting smart phone application, determine the target value of the signal-to-noise ratio that meets his own expectation, and feed back the target value of the signal-to-noise ratio to the hearing aid.

For example, if the user believes that the suggested value of the signal-to-noise ratio meets the expectation and the current signal-to-noise ratio level does not need to be adjusted, the suggested value of the signal-to-noise ratio can be determined as the target value of the signal-to-noise ratio through the button on the hearing aid or the supporting smart phone application, and the target value of the signal-to-noise ratio can be fed back to the hearing aid side. If the user believes that the suggested value of the signal-to-noise ratio does not meet the expectation and the current signal-to-noise ratio level needs to be adjusted, the suggested value of the signal-to-noise ratio can be adjusted (for example, increased or decreased) through the button on the hearing aid or the supporting smart phone application to determine the target value of the signal-to-noise ratio that meets his own expectation, and then the target value of the signal-to-noise ratio is fed back to the hearing aid. After receiving the target value of the signal-to-noise ratio fed back by the user, the hearing aid processes the subsequent sound signals according to the target value of the signal-to-noise ratio to meet hearing aid requirements of the user. In this example, by pushing the signal-to-noise ratio information to the user, user participation is improved, and the personalized noise reduction can be realized according to the user’s requirements.

In some examples, the method further includes reducing a low-frequency gain and/or pausing playback of media data when the user’s intention is recognized as the speaking intention.

In practical applications, when the user speaks, his voice can be transmitted to inner ears through bones, which makes the user feel that his voice is louder than the actual voice, especially at a low-frequency part. This phenomenon is called “ear-blocking effect”. In order to reduce influence of the ear blocking effect on the user, the gain at the low-frequency part can be reduced to decrease turbidity of the sound and improve user experience.

Therefore, in specific implementation, the hearing aid can detect the user’s intention in real time through the bone voiceprint sensor and determine whether the user is speaking. If the hearing aid identifies that the user is speaking, the low-frequency gain can be reduced to decrease ear-blocking feeling.

When the user is listening to external media data (such as music and TV programs) while speaking, these media sounds may interfere with the user’s communication. Therefore, when identifying that the user is speaking, the hearing aid can automatically pause playback of media content, so that the user can pay more attention to conversation while speaking, thus reducing influence of background noise. It can be understood that the hearing aid can reduce the low-frequency gain and pause playback of media data at the same time to maximize listening experience of the user. In this example, the user’s listening experience can be significantly improved by reducing the low-frequency gain and pausing playback of the media data.

Considering that the hearing aid can be equipped with an AI (Artificial Intelligence) processing module, the AI model can be used for noise reduction of speech. In some examples, the method further includes: extracting the environmental feature of the sound signal collected by the microphone, inputting the environmental feature and the user’s hearing feature data, calling a trained sound signal processing model to identify the environmental scene corresponding to the sound signal, determining the first signal-to-noise ratio and the second signal-to-noise ratio matching the environmental scene, performing noise reduction on the sound signal based on the first signal-to-noise ratio or the second signal-to-noise ratio, and outputting the noise-reduced sound signal.

The sound signal processing model is trained based on hearing data of different users and first signal-to-noise ratios and second signal-to-noise ratios in different environmental scenes. In this example, a speech recognition model can be a deep learning model or an end-to-end AI model. The end-to-end AI model can directly learn from original input data to final output without explicit manual feature engineering or human intervention in intermediate steps.

For example, a training process of the speech recognition model can be as follows. Test results of speech recognition threshold tests under information masking of different users in different environmental scenes are collected, including Nk_SRTx and Nk_SRT50 in different environmental scenes and hearing data of different users, so as to construct an original data set. Then, environmental features and the user’s hearing feature data in the original data set are extracted, and a corresponding environmental scene label is added to each piece of data, and the corresponding first signal-to-noise ratio and second signal-to-noise ratio are marked for each environmental scene. Then, an appropriate machine learning or deep learning model, such as a convolutional neural network, is selected to construct an initial sound signal processing model, and the environmental features, hearing feature data and corresponding environmental scene labels are input to the initial sound signal processing model for training, so that the model can predict different environmental scenes and the first signal-to-noise ratios and second signal-to-noise ratios corresponding to the different environmental scenes.

In practical applications, the environmental features of the sound signal collected by the microphone are extracted by the model, and the trained sound signal processing model is called with the environmental features and the user’s hearing feature data as inputs. The model predicts the environmental scene corresponding to the sound signal and the first signal-to-noise ratio and the second signal-to-noise ratio matching the environmental scene. Meanwhile, the target value of the signal-to-noise ratio is determined based on the first signal-to-noise ratio or the second signal-to-noise ratio, and the noise reduction parameters are adjusted through the target value of the signal-to-noise ratio, and then the noise-reduced sound signal is output to the user.

In this example, noise can be reduced by the trained sound signal processing model, which can not only identify the current environmental scene more accurately, but also automatically perform personalized noise reduction according to the user’s hearing data. Moreover, the model is suitable for more scene recognition and can effectively improve the user’s experience.

In order to describe the noise reduction method for the sound signal provided in the disclosure more clearly, a specific example will be described below, which comprises following steps:

S100: acquiring a sound signal collected by a microphone;

S102: extracting a first environmental feature of the sound signal;

S104: clustering second environmental features of different environmental scenes to obtain a clustering result, determining a distance between each cluster center in the clustering result and the first environmental feature, and determining an environmental scene characterized by a nearest cluster center as an environmental scene corresponding to the sound signal;

S106: determining a first signal-to-noise ratio and a second signal-to-noise ratio matching the environmental scene, the first signal-to-noise ratio being a signal-to-noise ratio when a user reaches a maximum speech recognition score with a hearing aid, and the second signal-to-noise ratio being a signal-to-noise ratio when a user reaches a speech recognition threshold with a hearing aid;

S108: acquiring a vibration signal of a bone conduction vibrator, determining a vibration pattern based on the acquired vibration signal, and identifying the user’s intention based on the vibration pattern;

S110: if the identified user’s intention is silence intention, determining a suggested value of the signal-to-noise ratio based on the second signal-to-noise ratio, the suggested value of the signal-to-noise ratio being greater than the second signal-to-noise ratio, pushing signal-to-noise ratio information with the suggested value of the signal-to-noise ratio for the user to adjust to obtain a target value of the signal-to-noise ratio based on the suggested value of the signal-to-noise ratio, and receiving the target value of the signal-to-noise ratio fed back by the user; and

S112: if the identified user’s intention is speaking intention, determining the first signal-to-noise ratio as the target value of the signal-to-noise ratio to reduce low-frequency gain.

It should be understood that, although the various steps in the flowcharts involved in the examples described above are displayed in the order indicated by the arrows, these steps are not necessarily performed in the order indicated by the arrows. Unless explicitly stated herein, there is no strict sequential restriction on the execution of these steps, and they may be performed in other orders. Furthermore, at least some of the steps in the flowcharts involved in the examples described above may include multiple steps or multiple stages, and these steps or stages are not necessarily completed at the same time but may be executed at different times. The execution order of these steps or stages is also not necessarily sequential but may alternate or interleave with at least part of other steps, or at least part of steps or stages in other steps.

Based on the same inventive concept, an example of the disclosure further provides a noise reduction apparatus for a sound signal configured to implementing the noise reduction method for a sound signal. The solution provided by the apparatus for addressing the problem is similar to the implementation solution described in the foregoing method. Therefore, the specific limitations of one or more examples of the noise reduction apparatus for a sound signal provided below may refer to the above limitations of the noise reduction method for a sound signal, and will not be repeated here.

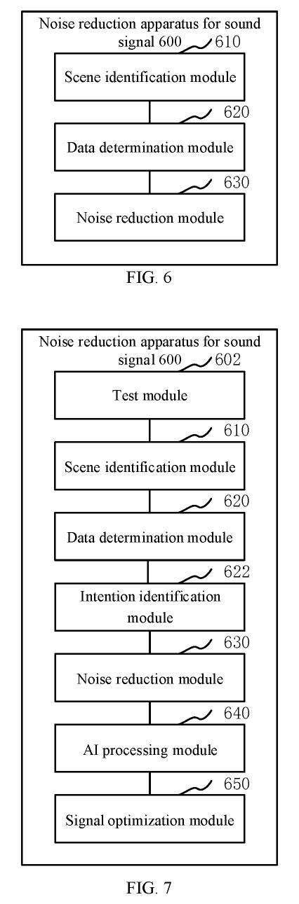

In an example, as shown in FIG. 6, a noise reduction apparatus 600 for a sound signal is provided, which includes a scene identification module 610, a data determination module 620 and a noise reduction module 630, in which the scene identification module 610 is configured to identify an environmental scene corresponding to a sound signal collected by a microphone based on the sound signal; the data determination module 620 is configured to determine a first signal-to-noise ratio and a second signal-to-noise ratio that match the environmental scene, the first signal-to-noise ratio being a signal-to-noise ratio when a user reaches a maximum speech recognition score with a hearing aid, and the second signal-to-noise ratio being a signal-to-noise ratio when a user reaches a speech recognition threshold with a hearing aid; and the noise reduction module 630 is configured to perform noise reduction on the sound signal based on the first signal-to-noise ratio or the second signal-to-noise ratio.

The noise reduction apparatus for the sound signal identifies the environmental scene corresponding to the sound signal based on the sound signal collected by the microphone, then determines the signal-to-noise ratio (the first signal-to-noise ratio) corresponding to a user’s maximum speech recognition score in this scene and a signal-to-noise ratio (the second signal-to-noise ratio) corresponding to a user’s speech recognition threshold based on the environmental scene, so as to quantify user’s tolerance and sensitivity to noise, and then performs noise reduction based on the first signal-to-noise ratio or the second signal-to-noise ratio, so that the noise reduction can effectively remove noise without excessively weakening useful signals, thus achieving a personalized noise reduction effect according to noise tolerance of the user and environmental conditions, and enabling the user to hear clearer voices in various environments. Moreover, the apparatus can automatically adjust a noise reduction strategy according to different environmental scenes, which is suitable for various noise environments and improves adaptability and flexibility.

As shown in FIG. 7, in another example, the apparatus further includes an intention identifying module 622 configured to identify the user’s intention; and the noise reduction module 630 further configured to determine a target value of the signal-to-noise ratio through the first signal-to-noise ratio or the second signal-to-noise ratio for the identified user’s intention; and perform noise reduction on the sound signal based on the target value of the signal-to-noise ratio.

In another example, the noise reduction module 630 is further configured to determine the first signal-to-noise ratio as the target value of the signal-to-noise ratio when the identified user’s intention is speaking intention; and determine the target value of the signal-to-noise ratio based on the second signal-to-noise ratio when the identified user’s intention is silence intention.

In another example, the noise reduction module 630 is further configured to determine a suggested value of the signal-to-noise ratio based on the second signal-to-noise ratio, the suggested value of the signal-to-noise ratio being greater than the second signal-to-noise ratio; push signal-to-noise ratio information with the suggested value of the signal-to-noise ratio for the user to adjust to obtain the target value of the signal-to-noise ratio based on the suggested value of the signal-to-noise ratio; and receive the target value of the signal-to-noise ratio fed back by the user.

In another example, the intention identifying module 622 is further configured to acquire a vibration signal of a bone conduction vibrator; and identify the user’s intention based on the vibration signal.

In another example, the intention identifying module 622 is further configured to determine a vibration pattern based on the vibration signal; and identify the user’s intention based on the vibration pattern.

In another example, the scene identification module 610 is further configured to extract a first environmental feature of the sound signal; and match the first environmental feature with second environmental features of different environmental scenes to identify the environmental scene corresponding to the sound signal.

In another example, the scene identification module 610 is further configured to cluster the second environmental features of different environmental scenes to obtain a clustering result; determine a distance between each cluster center in the clustering result and the first environmental feature; and determine an environmental scene characterized by a nearest cluster center as the environmental scene corresponding to the sound signal.

As shown in FIG. 7, in another example, the apparatus further includes an AI processing module 640 configured to extract the environmental feature of the sound signal collected by the microphone, input the environmental feature and the user’s hearing feature data, call a trained sound signal processing model to identify the environmental scene corresponding to the sound signal, determine the first signal-to-noise ratio and the second signal-to-noise ratio matching the environmental scene, perform noise reduction on the sound signal based on the first signal-to-noise ratio or the second signal-to-noise ratio, and output the noise-reduced sound signal, in which the sound signal processing model is trained based on hearing data of different users and first signal-to-noise ratios and second signal-to-noise ratios in different environmental scenes.

As shown in FIG. 7, in another example, the apparatus further includes a test module 602 configured to perform speech recognition threshold tests under information masking on the user under different signal-to-noise ratio levels in various environmental scenes to obtain test results; and determine first signal-to-noise ratios and second signal-to-noise ratios for the user in the different environmental scenes according to the test results and the user’s hearing data.

In another example, the apparatus further includes a signal optimization module 650 configured to reduce a low-frequency gain and/or pause playback of media data when the recognized user’s intention is speaking intention.

All or part of the modules in the maintenance device of a print head may be implemented in software, hardware, or a combination of both. The above modules may be embedded in or independent of the processor of the computer device in a hardware form, or stored in the memory of the computer device in a software form, so that the processor can invoke and execute the operations corresponding to the above modules.

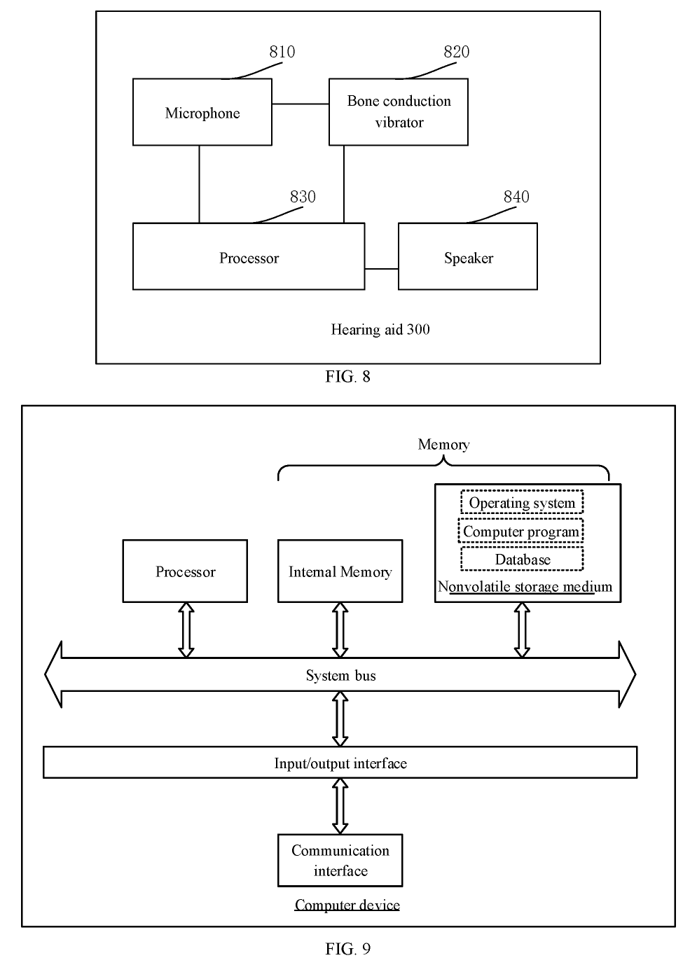

As shown in FIG. 8, in an example, the disclosure further provides a hearing aid 800, which comprises a microphone 810, a bone conduction vibrator 820, a processor 830 and a speaker 840. The processor 830 is connected with the microphone 810, the speaker 840 and the bone conduction vibrator 820.

The bone conduction vibrator 820 is configured to identify the user’s intention based on the captured vibration signal and send the identified user’s intention to the processor 830.

The microphone 810 is configured to collect sound signals and send the sound signals to the processor 830. The processor 830 is configured to perform the steps in the above noise reduction method for the sound signal, perform noise reduction on the sound signals, and send the noise-reduced sound signals to the speaker 840.

It can be understood by those skilled in the art that the structure of the hearing aid is merely part of the structure related to the solution of the present disclosure, and does not limit the hearing aid to which the present solution is applied. The specific hearing aid may include more or less components than those shown in the figure, may combine certain components, or may have a different component arrangement.

In an example, a computer device is provided, which may be a server, and an internal structure diagram may be as shown in FIG. 9. The computer device includes a processor, a memory, an input/output interface (I/O for short), and a communication interface. The processor, the memory and the input/output interface are connected through a system bus, and the communication interface is connected to the system bus through the input/output interface. The processor of the computer device is configured to provide computing and control capabilities. The memory of the computer device includes a nonvolatile storage medium and an internal memory. The nonvolatile storage medium stores an operating system, a computer program and a database. The internal memory provides an environment for execution of the operating system and the computer program in the nonvolatile storage medium. The database of the computer device is configured to store signal-to-noise ratio level data in different environmental scenes as well as the user’s hearing data. The input/output interface of the computer device is configured to exchange information between the processor and external devices. The communication interface of the computer device is configured to communicate with external terminals through network connection. The computer program, when executed by the processor, realizes the noise reduction method for the sound signal.

It can be understood by those skilled in the art that the structure shown in FIG. 9 is a block diagram illustrating part of the structure related to the solution of the present disclosure, and does not limit the computer device to which the present solution is applied. The specific computer device may include more or less components than those shown in the figure, may combine certain components, or may have a different component arrangement.

In an example, a computer device is provided, including a memory in which a computer program is stored; and a processor that implements the steps of any one of the above examples of the noise reduction method for the sound signal when executing the computer program.

In an example, a computer-readable storage medium is provided, on which a computer program is stored, and implements the steps of any one of the above examples of the noise reduction method for the sound signal when executed by a processor.

In an example, a computer program product is provided, including a computer program that implements the steps of any one of the above examples of the noise reduction method for the sound signal when executed by a processor.

It should be noted that the user information (including but not limited to user device information, user’s hearing information, etc.) and data (including but not limited to data for analysis, stored data, displayed data, etc.) involved in the disclosure are all information and data authorized by the user or fully authorized by all parties, and collection, use and processing of relevant data need to comply with relevant regulations.

Those skilled in the art can understand that all or part of the processes in the above examples can be accomplished by instructing relevant hardware through a computer program. The computer program can be stored in a non-volatile computer-readable storage medium, and may include the processes of the examples of the above methods when executed. Any reference to memory, database, or other media used in the examples provided in the present disclosure may include at least one of non-volatile and volatile memories. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, and the like. As an illustration and not a limitation, the RAM may take various forms, such as a static random access memory (SRAM) or a dynamic random access memory (DRAM), and the like. The databases involved in the examples provided in the present disclosure may include at least one of relational databases and non-relational databases. Non-relational databases may include distributed databases based on blockchain, but are not limited to these. The processors involved in the examples provided in the present disclosure may be general-purpose processors, central processing units, graphics processors, digital signal processors, programmable logic units, quantum computing based data processing logic units, artificial intelligence (AI) processors and the like, but are not limited to these.

The technical features of the above examples can be combined. For conciseness of description, not all possible combinations of the technical features in the examples described above are described. However, these combinations should be within the scope of the description as long as no contradiction occurs in the combinations of these technical features.

The above examples represent only several examples of the present disclosure, which are described specifically in detail, but should not be construed thus as limitations on the scope of the present disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. A noise reduction method, comprising:
identifying an environmental scene based on a sound signal collected by a microphone of a hearing aid;
determining, for a user, a first signal-to-noise ratio based on the user achieving a maximum speech recognition rate in the environment scene with the hearing aid;
determining, for the user, a second signal-to-noise ratio based on the user achieving a predetermined speech recognition threshold in the environment scene with the hearing aid; and
performing noise reduction on the sound signal based on the first signal-to-noise ratio or the second signal-to-noise ratio.

2. The noise reduction method of claim 1, wherein the performing noise reduction on the sound signal based on the first signal-to-noise ratio or the second signal-to-noise ratio comprises:
identifying an intention of the user;
determining a target value of a signal-to-noise ratio based on the first signal-to-noise ratio or the second signal-to-noise ratio for the identified intention; and
performing noise reduction on the sound signal based on the target value of the signal-to-noise ratio.

3. The noise reduction method of claim 2, wherein the determining the target value of the signal-to-noise ratio comprises:
when the identified intention is to speak, determining the first signal-to-noise ratio as the target value of the signal-to-noise ratio; and
when the identified intention is to not speak, determining the second signal-to-noise ratio as the target value of the signal-to-noise ratio.

4. The noise reduction method of claim 2, wherein the determining the target value of the signal-to-noise ratio based on the first signal-to-noise ratio or the second signal-to-noise ratio comprises:
determining a suggested value of the signal-to-noise ratio based on the second signal-to-noise ratio, the suggested value of the signal-to-noise ratio being greater than the second signal-to-noise ratio;
outputting the suggested value of the signal-to-noise ratio for the user to adjust; and
receiving the target value of the signal-to-noise ratio from the user.

5. The noise reduction method of claim 1, wherein the identifying the environmental scene comprises:
extracting a first environmental feature of the sound signal; and
matching the first environmental feature with second environmental features of different environmental scenes to identify the environmental scene, wherein the second environmental features are associated with at least one of a frequency spectrum, a time domain, or a modulation scheme.

6. The noise reduction method of claim 5, wherein the matching comprises:
clustering the second environmental features of different environmental scenes to obtain a clustering result;
determining a distance between each cluster center in the clustering result and the first environmental feature; and
determining an environmental scene characterized by a nearest cluster center as the environmental scene corresponding to the sound signal.

7. The noise reduction method of claim 1, further comprising:
extracting an environmental feature from the sound signal;
inputting the environmental feature and hearing feature data of the user; and
identifying, based on a sound signal processing model, the environmental scene corresponding to the sound signal.

8. The noise reduction method of claim 7, wherein the sound signal processing model is trained based on hearing data of different users and first signal-to-noise ratios and second signal-to-noise ratios in different environmental scenes.

9. The noise reduction method of claim 1, further comprising:
performing speech recognition threshold tests on the user under different signal-to-noise ratio levels in a plurality of environmental scenes to obtain test results; and
determining first signal-to-noise ratios and second signal-to-noise ratios for the user in the plurality of environmental scenes based on the test results and hearing data of the user.

10. The noise reduction method of claim 2, wherein the identifying the intention comprises:
acquiring a vibration signal of a bone conduction vibrator of the hearing aid; and
identifying the intention based on the vibration signal.

11. The noise reduction method of claim 10, wherein the identifying the intention based on the vibration signal comprises:
determining a vibration pattern based on the vibration signal; and
identifying the intention based on the vibration pattern.

12. The noise reduction method of claim 2, further comprising:
when the identified intention is to speak, performing at least one of:
reducing a low-frequency gain; or
pausing playback of media data.

13. A hearing aid comprising a microphone, a speaker, a bone conduction vibrator, and one or more processors, wherein the hearing aid is configured to:
identify an environmental scene based on a sound signal collected by a microphone;
determine, for a user, a first signal-to-noise ratio based on the user achieving a maximum speech recognition rate in the environment scene with the hearing aid;
determine, for the user, a second signal-to-noise ratio based on the user achieving a predetermined speech recognition threshold in the environment scene with the hearing aid; and
perform noise reduction on the sound signal based on the first signal-to-noise ratio or the second signal-to-noise ratio.

14. The hearing aid of claim 13, wherein the hearing aid is further configured to:
identify an intention of the user;
determine a target value of a signal-to-noise ratio based on the first signal-to-noise ratio or the second signal-to-noise ratio for the identified intention; and
perform noise reduction on the sound signal based on the target value of the signal-to-noise ratio.

15. The hearing aid of claim 14, wherein the hearing aid is further configured to:
when the identified intention is to speak, determine the first signal-to-noise ratio as the target value of the signal-to-noise ratio; and
when the identified intention is to not speak, determine the second signal-to-noise ratio as the target value of the signal-to-noise ratio.

16. The hearing aid of claim 14, wherein the hearing aid is further configured to:
determine a suggested value of the signal-to-noise ratio based on the second signal-to-noise ratio, the suggested value of the signal-to-noise ratio being greater than the second signal-to-noise ratio;
output the suggested value of the signal-to-noise ratio for the user to adjust; and
receive the target value of the signal-to-noise ratio from the user.

17. The hearing aid of claim 13, wherein the hearing aid is further configured to:
extract an environmental feature of the sound signal;
input the environmental feature and hearing feature data of the user; and
identify, based on a sound signal processing model, the environmental scene corresponding to the sound signal.

18. The hearing aid of claim 14, wherein the hearing aid is further configured to:
acquire a vibration signal of the bone conduction vibrator of the hearing aid; and
identify the intention based on the vibration signal.

19. A noise reduction method, comprising:
obtaining a sound signal collected by a microphone of a hearing aid;
identifying, based on parameters of the sound signal, an environmental scene;
determining, for a user, a signal-to-noise ratio for the user in the environmental scene based on:
an intention of the user,
a noise reduction setting input by the user, and
a speech recognition threshold in the environment scene of the user with the hearing aid; and
performing noise reduction on the sound signal based on the determined signal-to-noise ratio.

20. The noise reduction method of claim 19, wherein the hearing aid comprises a bone conduction vibrator, and the noise reduction method further comprises:
determining the intention of the user based on a vibration pattern of a vibration signal of the bone conduction vibrator.
